(19) United States
(12) Patent Application Publication
(10) Pub. No.: US 2016/0252668 A1
(43) Pub. Date: Sep. 1, 2016

(54) DISPLAY DEVICE AND BACKLIGHT MODULE

(71) Applicant: Shenzhen China Star Optoelectronics Technology Co., Ltd., Guangdong (CN)

(72) Inventors: Yu-Chum Hsiao, Guangdong (CN); Shih Hsiang Chen, Guangdong (CN); Guofu Tang, Guangdong (CN); Quan Li, Guangdong (CN); Chengling Lv, Guangdong (CN); Chaofan Guo, Guangdong (CN)

(21) Appl. No.: 14/415,710

(22) PCT Filed: Nov. 12, 2014
(86) PCT No.: PCT/CN2014/090856

§ 371 Date: Sep. 1, 2015

(30) Foreign Application Priority Data
Nov. 7, 2014 (CN) 201410624762.9

(51) Int. Cl. F21V 8/00

(52) U.S. Cl. CPC G02B 6/0008

(57) ABSTRACT

A display device and a backlight module are provided. The display device includes a display panel and a backlight module. The display panel is configured to display images and illuminated by a first light and a second light. A light source providing plane of the backlight module is configured to receive the first light and is illuminated by the second light. Thus, viewers can see objects in back of a display panel through the display panel.

### FIELD OF THE INVENTION

The present invention relates to a technical field of a display, and in particular to a display device and a backlight module.

### BACKGROUND OF THE INVENTION

Generally, a traditional display panel is not transparent (opaque). That is, light rays cannot be irradiated through the display panel.

For example, a first back plate is disposed in a backlight module of a Liquid Crystal Display (LCD), and the first back plate is not transparent.

For instance, a second back plate is disposed in at back side of an OLED (Organic Light Emitting Diode), and the second back plate is also not transparent.

Thus, viewers cannot see objects in back of a display panel through the display panel.

Therefore, new technical solutions are desired to be developed, so as solve the problems existing in the conventional as described above.

### SUMMARY OF THE INVENTION

An object of the present invention is to provide a display device and a backlight module, so that viewers can see objects in back of a display panel through the display panel.

To achieve the above object, the present invention provides a display device which comprises a display panel and a backlight module, the display panel includes at least two pixel units, a first surface and a second surface opposite the first surface, wherein the display panel is configured to display images, and the second surface is illuminated by a first light and a second light, and the backlight module provides the first light to the display panel and comprises a light source and a light source, the light source configured to generate the first light, and the light source providing plane having a third surface and a fourth surface opposite the third surface and receiving the first light and providing the first light to the display panel, wherein the light source is disposed on a side of the light source providing plane, and the fourth surface is illuminated by the second light, wherein the display panel is disposed on the backlight module, and the second surface of the display panel is connected to the third surface of the light source providing plane. The light source providing plane further comprises a fifth surface, at least two light input interfaces, and at least two light providing units, the fifth surface being located a side of the light source providing plane, the light input interfaces disposed on the fifth surface and connected to the light source for received the first light, the light providing units opposite the display panel and comprising a light output interface and at least one light transmission channel, the light output interface configured to change a transmission direction of the first light, wherein the first light illuminates the pixel units from the light output interface. The light transmission channel connects to the light output interface for transmitting the first light from the light source to the light output interface, wherein backlight module has a light transmittance for irradiating through the light source providing plane ranged from 10% to 99.9%.

In one embodiment of the present invention, the light transmission channel is an optical fiber.

In one embodiment of the present invention, the light output interface comprises an inclined plane and includes an angle with the light source providing plane, and the inclined plane reflects the first light from the optical fiber to the pixel units.

In one embodiment of the present invention, the light output interface comprises a curved surface, and the curved surface reflects the first light from the optical fiber to the pixel units.

The present invention provides a display device which comprises a display panel and a backlight module, the display panel includes at least two pixel units, a first surface, and a second surface opposite the first surface, wherein the display panel is configured to display images, and the second surface is illuminated by a first light and a second light, and the backlight module provides the first light to the display panel and comprises a light source and a light source, the light source configured to generate the first light, and the light source providing plane having a third surface and a fourth surface opposite the third surface and receiving the first light and providing the first light to the display panel, wherein the light source is disposed on a side of the light source providing plane, and the fourth surface is illuminated by the second light, wherein the display panel is disposed on the backlight module, and the second surface of the display panel is connected to the third surface of the light source providing plane.

In one embodiment of the present invention, the light source providing plane further comprises a fifth surface, at least two light input interfaces, and at least two light providing units, the fifth surface being located at a side of the light source providing plane, the light input interfaces disposed on the fifth surface and connected to the light source for receiving the first light, the light providing units opposite the display panel and comprising a light output interface and at least one light transmission channel, the light output interface configured to change a transmission direction of the first light, wherein the first light illuminates the pixel units from the light output interface, the light transmission channel connects to the light output interface for transmitting the first light from the light source to the light output interface.

In one embodiment of the present invention, the light transmission channel is an optical fiber.

In one embodiment of the present invention, the light output interface comprises an inclined plane and includes an angle with the light source providing plane, and the inclined plane reflects the first light from the optical fiber to the pixel units.

In one embodiment of the present invention, a plurality of scattering particles are disposed on the inclined plane for scattering the first light to the pixel units.

In one embodiment of the present invention, the light output interface comprises a curved surface, and the curved surface reflects the first light from the optical fiber to the pixel units.

In one embodiment of the present invention, the curved surface is a convex surface for reflecting the first light to an area of the pixel unit.

In one embodiment of the present invention, the curved surface is a concave surface for reflecting the first light to an area of the pixel unit.

The present invention provides a backlight module which provides a first light to the display panel and comprises a light source, and a light source providing plane, the light source configured to generate the first light, the light source providing plane has a third surface and a fourth surface opposite the third surface and receives the first light and providing the first light to the display panel, wherein the light source is disposed on a side of the light source providing plane, and the fourth surface is illuminated by the second light, and the display panel is disposed on the backlight module, and the second surface of the display panel is connected to the third surface of the light source providing plane.

In one embodiment of the present invention, the light source providing plane further comprises a fifth surface, at least two light input interfaces, and at least two light providing units, the fifth surface being located at a side of the light source providing plane, the light input interfaces disposed on the fifth surface and connected to the light source for receiving the first light, the light providing units opposite the display panel and comprising a light output interface and at least one light transmission channel, the light output interface configured to change a transmission direction of the first light, wherein the first light illuminates the pixel units from the light output interface, the light transmission channel connects to the light output interface for transmitting the first light from the light source to the light output interface.

In one embodiment of the present invention, the light transmission channel is an optical fiber.

In one embodiment of the present invention, the light output interface comprises an inclined plane and includes an angle with the light source providing plane, and the inclined plane reflexes the first light from the optical fiber to the pixel units.

In one embodiment of the present invention, a plurality of scattering particles are disposed on the inclined plane for scattering the first light to the pixel units.

In one embodiment of the present invention, the light output interface comprises a curved surface, and the curved surface reflects the first light from the optical fiber to the pixel units.

In one embodiment of the present invention, the curved surface is a convex surface for reflecting the first light to an area of the pixel unit.

In one embodiment of the present invention, the curved surface is a concave surface for reflecting the first light to an area of the pixel unit.

Compared with the prior art, the present invention is to provide a display device which allows viewers to see objects in back of a display panel through the display panel.

The present invention is described in detail below by way of specific embodiments in conjunction with the accompanying drawings.

### DESCRIPTION OF THE DRAWINGS

FIG. 1 is a schematic view of a display device of the present invention;

FIG. 2 is a schematic view of a display device according to the first embodiment of the present invention;

FIG. 3 is a schematic view of a light source providing plane of the backlight module in FIG. 2 according to the first embodiment of the present invention;

FIG. 4 is a schematic view of a light source providing plane of the backlight module in FIG. 2 according to the second embodiment of the present invention;

FIG. 5 is a schematic view of a display device according to the second embodiment of the present invention;

FIG. 6 is a schematic view of a display device according to the third embodiment of the present invention; and

FIG. 7 is a schematic view of a display device according to the fourth embodiment of the present invention.

### DETAILED DESCRIPTION OF THE PREFERRED EMBODIMENTS

Regarding the words used in the present specification, “an embodiment” means used as an example, examples, or illustrations. In addition, in this specification and the appended claims the article “a” in general can be interpreted to mean “one or more” unless specified otherwise or clear from the context to be oriented to the singular form.

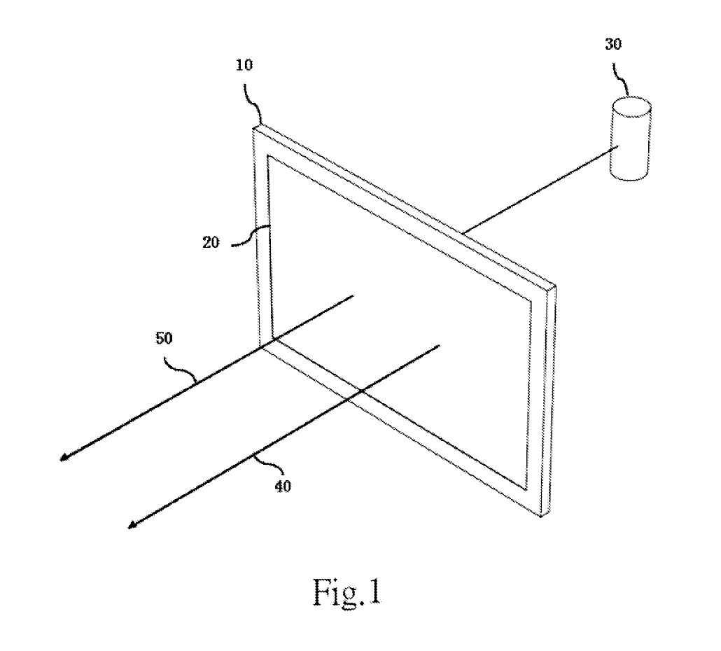

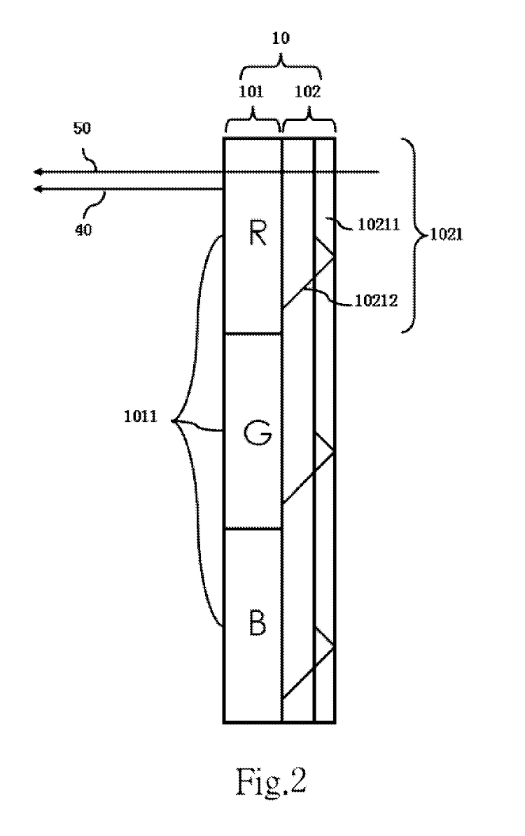

Referring to FIGS. 1 and 2, FIG. 1 is a schematic view of a display device 10 of the present invention, and FIG. 2 is a schematic view of a display device 10 according to the first embodiment of the present invention.

A display device 10 of the present invention comprises a display panel 101 and a backlight module 102, and the display panel 101 is disposed on the backlight module 102.

The display device 10 may be a Thin Film Transistor Liquid Crystal Display (TFT-LCD) or an Organic Light Emitting Diode (OLED). The display panel 101 includes at least two pixel units 1011, and the display panel 101 has a first surface and a second surface opposite the first surface. The display panel 101 is configured to display images, and the second surface is illuminated by a first light 40 and a second light 50. The second light 50 is emitted from an object 30 or reflected by the object 30.

In the embodiment, the backlight module 102 with a light transmittance is transparent or translucent. The backlight module 102 is configured to provide the first light 40 to display panel 101 and includes a light source and a light source providing plane.

The light source is configured to generate the first light 40. The light source providing plane has a third surface and a fourth surface opposite the third surface. The light source is disposed at one side of the light source providing plane. The light source providing plane is configured to receive the first light 40 and provide the first light 40 to the display panel 101, and the fourth surface is illuminated by the second light 50.

The light source providing plane has a light transmittance, and the light transmittance is a ratio of a light being emitted from the third surface to the second surface through the light source providing plane. The light transmittance is ranged from 10% to 99.9%. For example, 11.4%, 14.7%, 15.3%, 17.8%, 19.1%, 22.8%, 24.7%, 26.4%, 29.3%, 32.2%, 36.1%, 39.5%, 42.3%, 43.4%, 46.8%, 48.2%, 50.9%, 63.8%, 66.1%, 69.2%, 72.1%, 75.4%, 77.6%, 79.7%, 82.0%, 84.5%, 86.1%, 88.9%, 90.2%, 93.3%, 95.7%, 97.6%, 99.9%.

The second surface of the display panel 101 is opposite the third surface of the light source providing plane. Specifically, the second surface is in contact with the third surface.

In the embodiment, the light source providing plane further comprises a fifth surface, and the fifth surface is located at a side of the light source providing plane.

The light source providing plane has at least two light input interfaces, at least two light providing units 1021, and at least one light transmission channel.

The light input interfaces is disposed on the fifth surface and connects to the light source for received the first light 40.

The light providing units 1021 on the light source providing plane are opposite the pixel units 1011 on the display panel 101, and the light providing units 1021 include a light output interface.

The light output interface is configured to change a transmission direction of the first light 40 through at least one light transmission channel, so that the first light 40 illuminates the pixel units 1011 of the display panel 101 from the light output interface.

The light transmission channel connects to the light output interface for transmitting the first light 40 from the light source to the light output interface.

In the embodiment, the light transmission channel is an optical fiber 10211 for transmitting the first light 40. The optical fiber 10211 has a first end and a second end. The first end is located on the fifth surface and connects to the light source. The second end is connected to the light output interface.

In the embodiment, the light output interface comprises a smooth inclined plane 10212. The inclined plane 10212 includes an angle with the light source providing plane, and the inclined plane reflects the first light 40 from the optical fiber 10211 to the pixel units 1011.

In the embodiment, the optical fiber 10211 may be flat. That is, a cross section of the optical fiber 10211 may be rectangular. A long side of the cross section is parallel to a plane of the pixel units 1011, and a short side of the cross section is vertical with respect to the plane of the pixel units 1011.

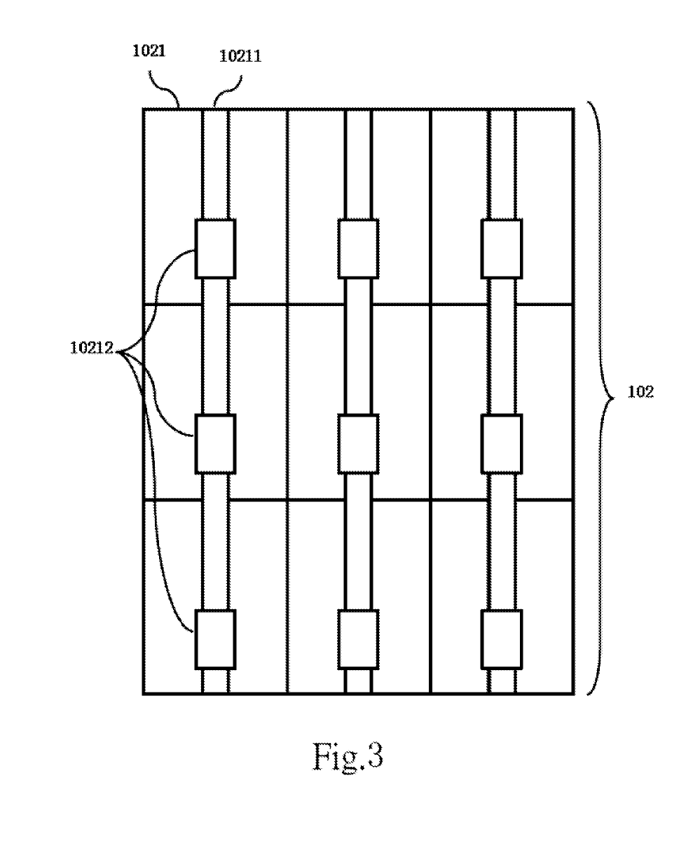

Referring to FIG. 3, a schematic view of a light source providing plane of the backlight module in FIG. 2 according to the first embodiment of the present invention is illustrated.

In the embodiment, an optical fiber 10211 provides the first light 40 to at least two light providing units 1021. For example, the optical fiber 10211 provides the first light 40 to a row of the light providing units 1021. The light providing units 1021 have at least two sections, each one of the sections is connected between the two adjacent light output interfaces. At least one section connects to the light output interface and the light input interface.

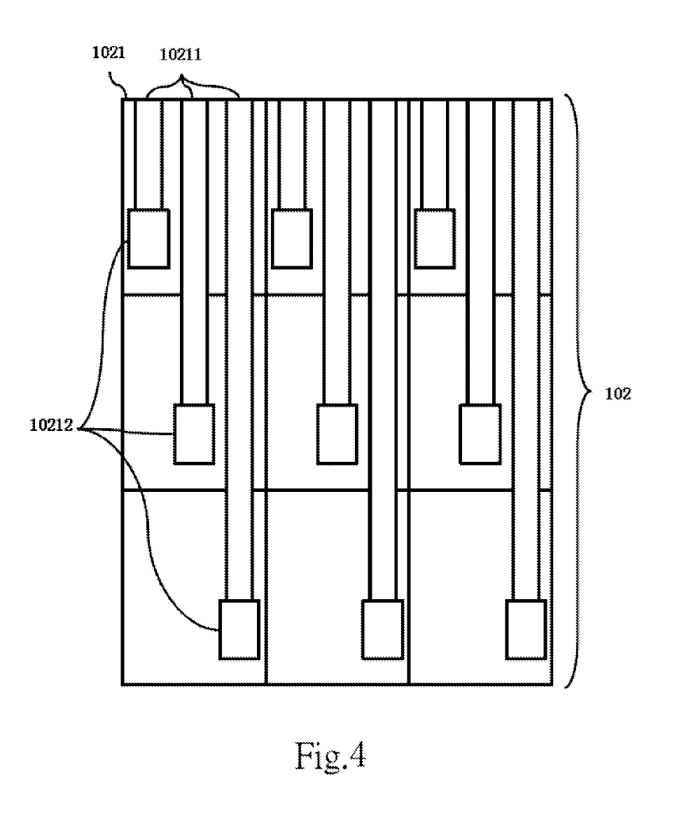

Referring to FIG. 4, a schematic view of a light source providing plane of the backlight module 102 in FIG. 2 according to the second embodiment of the present invention is illustrated.

Each of the optical fibers 10211 provides the first light 40 to single light providing units 1021, and the optical fibers 10211 are connected to the light output interface and the light input interface.

As stated above, the light source providing plane provides the first light 40 to the display panel 101 by the second light 50. Thus, viewers can see objects 30 in back of the display device 10 through the display device 10. When the display device 10 displays the images 20, the images 20 and the objects 30 are overlapped.

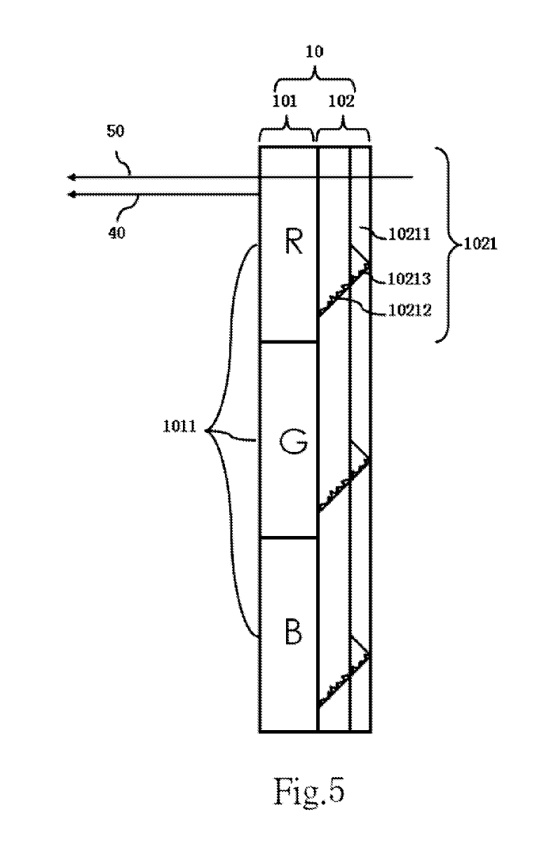

Referring to FIG. 5, a schematic view of a display device according to the second embodiment of the present invention is illustrated and is similar to the first embodiment.

The difference of the second embodiment is that the inclined plane 10212 is coarse. For example, a plurality of scattering particles 10213 are disposed on the inclined plane 10212 for scattering the first light 40 from the inclined plane 10212 to the pixel units 1011. The scattering particles 10213 are distributed unevenly on the inclined plane 10212. The shapes of the scattering particles 10213 are irregular, and each one of the scattering particles 10213 has a corner. Specifically, the scattering particles 10213 are polyhedrons and are transparent or translucent. The scattering particles 10213 can be transparent crystals, and are connected to the inclined plane 10212. The scattering particles 10213 and the light output interface can also be the same material, and the scattering particles 10213 are protruded from the light output interface by etching the inclined plane 10212.

Furthermore, an optical fiber 10211 provides the first light 40 to at least two light providing units 1021. A section of the optical fiber 10211 is connected between the two adjacent light output interfaces. The scattering particles 10213 are conducive to transmitting the first light 40 from a section of the optical fiber 10211 to another section. The first light 40 can avoid reflecting to the pixel units 1011 fully from the inclined plane 10212. Thus, the pixel units 1011 can be ensured to receive a light, and the light is roughly equal to the first light 40.

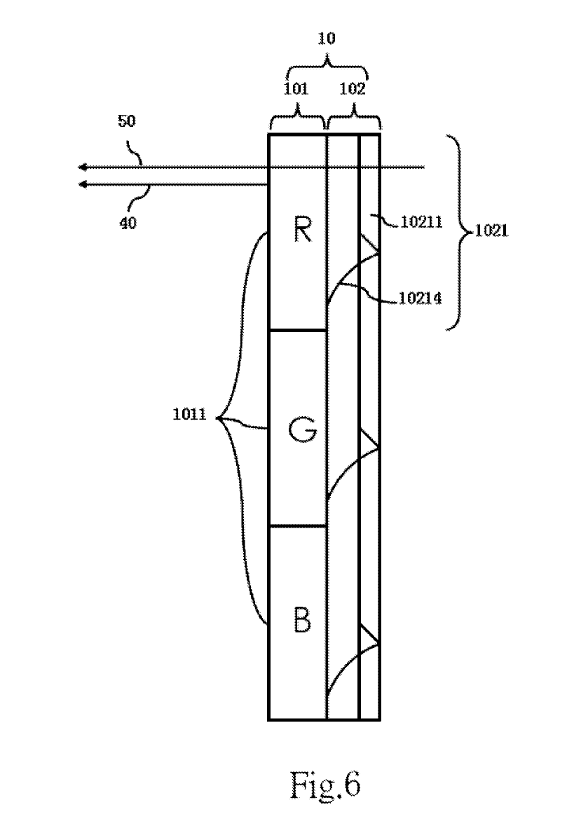

Referring to FIG. 6, a schematic view of a display device 10 according to the third embodiment of the present invention is illustrated and is similar to the first and second embodiments.

The difference of the third embodiment is that the light output interface comprises a curved surface, and the curved surface reflects the first light 40 from the optical fiber to the pixel units 1011.

Specifically, the curved surface is a convex surface 10214 for reflecting the first light 40 to an area of the pixel unit 1011.

In an improved embodiment, the convex surface 10214 also has the scattering particles 10213 of the second embodiment disposed thereon.

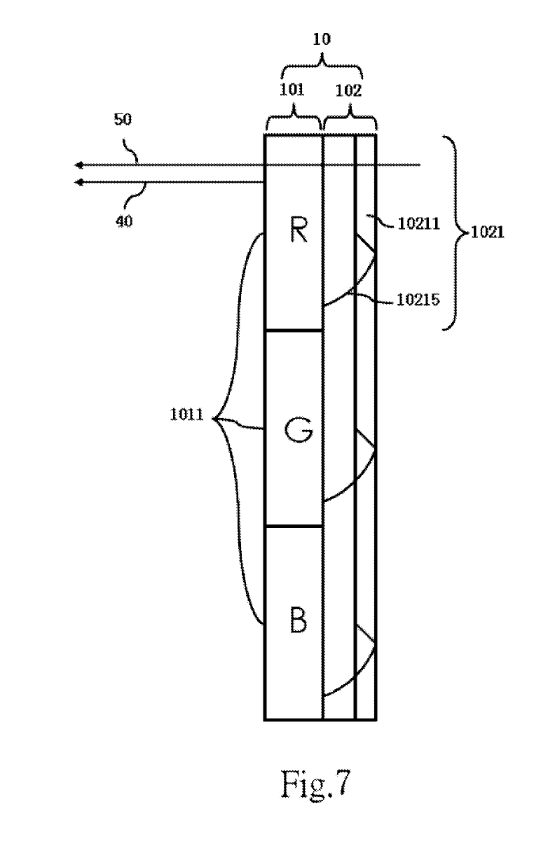

Referring to FIG. 7, a schematic view of a display device 10 according to the fourth embodiment of the present invention is illustrated and is similar to the third embodiment. The difference of the fourth embodiment is that the curved surface is a concave surface 10215 for reflecting the first light 40 to an area of the pixel unit 1011, such as a center area.

The display device 10 of the fourth embodiment is similar to the first, second, and third embodiments.

The difference of the fourth embodiment is that the light output interface consists of the inclined plane 10212 or any curved surface. For example, the light output interface includes at least two types of the inclined plane 10212, the convex surface 10214, and the concave surface 10215.

Moreover, despite relative to one or more implementations shown and described the present disclosure, various equivalent modifications will occur to those skilled in the art based on the present specification and drawings. The present disclosure includes all such modifications and variations, and is only limited by the scope of the appended claims. Particularly, with regard to various functions performed by the above-described components (e.g., elements, resources, etc.), the terms used to describe such components are intended to perform the function corresponding to the specified component (e.g., which is functionally equivalent) of any component (unless otherwise indicated), even if the structure of the implementation and execution of the function of the present disclosure is not structurally equivalent. Additionally, although a particular feature of the present disclosure has been made with respect to certain implementations, only one is open, but this feature may be as given or particular application and the purpose of enabling a desired one or more other implementations Other combinations of features. Moreover, the terms “comprising,” “having,” “containing,” or variants thereof as used in the detailed description or the claims are intended to be used in a manner similar to the term “comprising”.

The present invention has been described with preferred embodiments thereof and it is understood that many changes and modifications to the described embodiments can be carried out without departing from the scope and the spirit of the invention that is intended to be limited only by the appended claims.

What is claimed is:

1. A display device comprising:
a display panel including at least two pixel units, a first surface and a second surface opposite the first surface, wherein the display panel is configured to display images, and the second surface is illuminated by a first light and a second light; and
a backlight module providing the first light to the display panel and comprising:
a light source configured to generate the first light; and
a light source providing plane having a third surface and a fourth surface opposite the third surface and receiving the first light and providing the first light to the display panel, wherein the light source is disposed on a side of the light source providing plane, and the fourth surface is illuminated by the second light;
wherein the display panel is disposed on the backlight module, and the second surface of the display panel is connected to the third surface of the light source providing plane;
the light source providing plane further comprising:
a fifth surface located at a side of the light source providing plane;
at least two light input interfaces disposed on the fifth surface and connected to the light source for receiving the first light;
at least two light providing units opposite the display panel and comprising:
a light output interface configured to change a transmission direction of the first light, wherein the first light illuminates the pixel units from the light output interface; and
at least one light transmission channel connected to the light output interface for transmitting the first light from the light source to the light output interface;
wherein the backlight module has a light transmittance for irradiating through the light source providing plane ranged from 10% to 99.9%.

2. The display device according to claim 1, wherein the light transmission channel is an optical fiber.

3. The display device according to claim 2, wherein the light output interface comprises an inclined plane and includes an angle with the light source providing plane, and the inclined plane reflects the first light from the optical fiber to the pixel units.

4. The display device according to claim 2, wherein the light output interface comprises a curved surface, and the curved surface reflects the first light from the optical fiber to the pixel units.

5. A display device comprising:
a display panel including at least two pixel units, a first surface and a second surface opposite the first surface, wherein the display panel is configured to display images, and second surface is illuminated by a first light and a second light; and
a backlight module providing the first light to the display panel and comprising:
a light source configured to generate the first light; and
a light source providing plane having a third surface and a fourth surface opposite the third surface and receiving the first light and providing the first light to the display panel, wherein the light source is disposed on a side of the light source providing plane, and the fourth surface is illuminated by the second light;
wherein the display panel is disposed on the backlight module, and the second surface of the display panel is connected to the third surface of the light source providing plane.

6. The display device according to claim 5, wherein the light source providing plane further comprises:
a fifth surface located at a side of the light source providing plane;
at least two light input interfaces disposed on the fifth surface and connected to the light source for received the first light;
at least two light providing units opposite to the display panel and comprising:
a light output interface configured to change a transmission direction of the first light, wherein the first light illuminates the pixel units from the light output interface; and
at least one light transmission channel connected to the light output interface for transmitting the first light from the light source to the light output interface.

7. The display device according to claim 6, wherein the light transmission channel is an optical fiber.

8. The display device according to claim 7, wherein the light output interface comprises an inclined plane and includes an angle with the light source providing plane, and the inclined plane reflects the first light from the optical fiber to the pixel units.

9. The display device according to claim 8, wherein a plurality of scattering particles are disposed on the inclined plane for scattering the first light to the pixel units.

10. The display device according to claim 7, wherein the light output interface comprises a curved surface, and the curved surface reflects the first light from the optical fiber to the pixel units.

11. The display device according to claim 10, wherein the curved surface is a convex surface for reflecting the first light to an area of the pixel unit.

12. The display device according to claim 10, wherein the curved surface is a concave surface for reflecting the first light to an area of the pixel unit.

13. A backlight module providing a first light to the display panel and comprising:
a light source configured to generate the first light; and
a light source providing plane having a third surface and a fourth surface opposite the third surface and receiving the first light and providing the first light to the display panel, wherein the light source is disposed on a side of the light source providing plane, and the fourth surface is illuminated by the second light;
wherein the display panel is disposed on the backlight module, and the second surface of the display panel is connected to the third surface of the light source providing plane.

14. The backlight module according to claim 13, wherein the light source providing plane further comprises:
a fifth surface located at a side of the light source providing plane;
at least two light input interfaces disposed on the fifth surface and connected to the light source for received the first light;
at least two light providing units opposite the display panel and comprising:
a light output interface configured to change a transmission direction of the first light, wherein the first light illuminates the pixel units from the light output interface; and
at least one light transmission channel connected to the light output interface for transmitting the first light from the light source to the light output interface.

15. The backlight module according to claim 14, wherein the light transmission channel is an optical fiber.

16. The backlight module according to claim 15, wherein the light output interface comprises an inclined plane and includes an angle with the light source providing plane, and the inclined plane reflects the first light from the optical fiber to the pixel units.

17. The backlight module according to claim 16, wherein a plurality of scattering particles are disposed on the inclined plane for scattering the first light to the pixel units.

18. The backlight module according to claim 15, wherein the light output interface comprises a curved surface, and the curved surface reflects the first light from the optical fiber to the pixel units.

19. The backlight module according to claim 18, wherein the curved surface is a convex surface for reflecting the first light to an area of the pixel unit.

20. The backlight module according to claim 18, wherein the curved surface is a concave surface for reflecting the first light to an area of the pixel unit.
